(19) United States
(12) Patent Application Publication
(10) Pub. No.: US 2015/0376388 A1
(43) Pub. Date: Dec. 31, 2015

(54) DURABLE PARTIALLY WATER PERMEABLE ARTICLE AND A METHOD OF MAKING THEREOF

(71) Applicant: Stephen GRUNZINGER, (US)

(72) Inventor: Stephen GRUNZINGER, Scandia, MN (US)

(21) Appl. No.: 14/767,389

(22) PCT Filed: Feb. 5, 2014
(86) PCT No.: PCT/US14/14966

§ 371 Date: Aug. 12, 2015

Related U.S. Application Data
(60) Provisional application No. 61/763,938, filed on Feb. 12, 2013.

(51) Int. Cl. C08L 27/06; B29C 47/00

(52) U.S. Cl. CPC C08L 27/06; B29C 47/0007; B29C 47/0088; B29K 2027/06

(57) ABSTRACT

A durable partially water permeable article that can be used for transporting fluids such as water resulting from a co-continuous extruded structure.

### CROSS REFERENCE TO RELATE APPLICATION

This application claims the benefit of U.S. Provisional Application No. 61/763938 filed Feb. 12, 2013.

### FIELD OF THE INVENTION

The present invention relates to a durable partially water permeable article that can be used for transporting fluids such as water and a method of making the same.

### BACKGROUND OF THE INVENTION

Known methods of manufacturing porous structures used for transporting fluids such as water in soaker hoses and weeping tiles is to control moisture content of the resin or use blowing agents to form porous materials. Other methods include that discussed in U.S. Pat. No. 4,003,408 and similar publications for the incorporation of rubber particles into a polyethylene matrix. Such porous materials have a suitable structure, and while effective, do not provide the long term structural integrity which may be required for being buried underground and exposed to rocks and other heavy and tough objects while still delivering the desired water dispersal and/or collection. There still exists a need to provide an article for transporting fluids such as water that has improved structural integrity without limiting porosity.

### SUMMARY OF THE INVENTION

The present application relates to an article comprising a co-continuous structure, the co-continuous structure comprising a first phase of a water-impermeable engineering polymer and a second phase comprising at least one water soluble polymer; wherein the water-impermeable engineering polymer is present from 10 wt % to 99.99 wt % by weight of the co-continuous structure. The present application further relates to an article comprising a co-continuous structure, the co-continuous structure comprising a first phase of a water-impermeable engineering polymer and a second phase comprising at least one water soluble polymer; wherein the water-impermeable engineering polymer is present from 50 wt % to 99.99 wt % by weight of the co-continuous structure, further wherein the article comprises interconnecting voids in the first phase having an average diameter of 100 microns or less.

A process of making a durable partially water permeable article; mixing a water-impermeable engineering polymer and at least one water soluble polymer to form a melt; extruding the melt to form a co-continuous structure; the co-continuous structure comprising an interconnecting matrix of water-impermeable engineering polymer and an interconnecting matrix of at least one water soluble polymer; exposing the co-continuous structure to a volume of water to form a durable partially water permeable article.

### DETAILED DESCRIPTION OF THE INVENTION

The present application relates to the formation of a co-continuous structure of at least two phases comprising a first phase and a second phase, the first phase creating an interconnected matrix and the second phase creating an interconnected matrix for the formation of a durable partially water permeable article. These articles can be used for water dispersal or water collection, such as irrigation or weeping tile purposes. The co-continuous structure results from the melt extrusion of the first phase, a water-impermeable engineered polymer, and the second phase, a water soluble polymer, into the desired end article form. Once exposed to a volume of water, the co-continuous structure comprises an interconnected void volume as the first phase; the water soluble polymer allows material diffusion (water and water-soluble material) through the second phase interconnected matrix. In one embodiment, the co-continuous structure is a bi-continuous phase structure.

Bi-continuous phase structure—Bi-continuous phase structure has two distinct phases, where each phase has an uninterrupted pathway through the entire volume of the material. In the present application, if the first phase, the engineering polymer phase, is interrupted, the material will fall apart when placed in water. If the second phase, the water-soluble polymer phase, is interrupted, the material will not be water permeable. The combination of structural stability in water and the ability for water to diffuse through the bulk of the material is an indication of a bi-continuous phase structure.

Other suitable co-continuous structures include interconnected circular domain structures or interconnected elliptical domain structures of the second phase (minor component) in the first phase (major component). Lamellae structures are suitable should the resulting co-continuous phase structure allow for the first phase to have an interconnected structure and the second phase to have an interconnected structure.

Water-impermeable engineering polymer. The water-impermeable engineering polymer may be present from 10 wt % to 99.99 wt % by weight of the co-continuous structures before any exposure to any water, such as from 50 wt % to 99.99 wt %, such as 75 wt % to 99.99 wt %, such as 85 wt % to 99.99 wt %, such as 85 wt % to 99.99 wt %, such as 93 wt % to 99,99 wt %. The water-impermeable engineering polymer provides the improvement in the structural integrity for the desired end article form. It may be selected for its water-impermeability, durability, it ability to form a co-continuous phase interconnecting structure with the water soluble polymer in the melt phase, and for its ability to be suitable for use in an extrusion process. Suitable water-impermeable engineering polymers may include polyvinyl chlorine (PVC), acrylonitrile butadiene styrene (ABS) and similar materials.

Water soluble polymer. The water soluble polymer may be present from 0.01 wt % to 90 wt % by weight of the co-continuous structures before any exposure to any water, such as 0.01 wt % to 50 wt %, such as from 0.01 wt % to 25 wt %, such as 0.01 wt % to 15 wt %, such as 0.01 wt % to 7 wt %. The water soluble polymer provides the original compatibility with the water-impermeable engineering polymer during the extrusion. The water soluble polymer eventually is eroded away from the water-impermeable engineering polymer to provide an interconnecting void structure in the water-impermeable engineering polymer through with water can enter or exit the finished article after the co-continuous structures is exposed to water (durable partially water permeable article). Suitable water soluble polymers may include polyethylene glycol (PEG)/polyethylene oxide (PEO), polyvinyl alcohol (PVA) and similar materials. Suitable PEO comprises an average Mᵥ from 1,000 to 5,000,000 such as −5,000,000 with a density of 1.21 g/mL at 25° C.

Other additives such as dyes, colorants, stabilizers, inhibitors or processing aids may also be added . Additives may be added from 0 to 50 phr (parts per hundred parts of resin), such as from 1 to 50 phr. Processing aids such as plasticizers are one suitable example of an additive that may be present. Suitable plasticizers include diisononyl phthalate. Fillers such as calcium carbonate may be present.

The first phase (water-impermeable engineering polymer), the second phase (water soluble polymer) and optional additives are fed into a barrel of an extruder, heated and then extruded to form article co-continuous structure. The heating profile is subject to the mixture used (first phase, second phase and optional additives) and individual components.

Other options steps include cooling steps, coating steps, machining steps and other suitable steps to arrive at the desired durable partially water permeable article.

A suitable durable partially water permeable article formed from the extruded co-continuous structure includes a tube, sheet, three dimensional container, film, block, cylinder (rod), or other formable object. The article may be selected to be suitable for delivery of water (irrigation, hydroponics), removal of water or fluids (weeping pipe, feminine/adult hygiene, baby/infant hygiene) and/or separations (desalinization). The article may be selected for use above or below ground for delivery of water, removal of water or separations.

Durability—the durability results from the water-impermeable engineering polymer portion of the durable partially water permeable article. Durability may be measure by tensile strength and modulus. The mechanical testing numbers (tensile strength and modulus) should be somewhere between filled PVC (hard white pipe) and plasticized PVC (Tygon® tubing).

Porosity—As used herein porosity is a measure of boles' that are an interconnected void volume in the durable partially water permeable article resulting the water soluble polymer volume that is eroded from the co-continuous structure with a solution such as water after the article is made. The “holes” would be cross sectional void volume shapes resulting from the interconnected network of water soluble polymer in the co-continuous structure that will have a range of diameters and orientations within in the co-continuous structure. The void shapes in the resulting durable partially water permeable article are “holes” approximating pores or voids having an average diameter of 100 microns or less, such as 0.01 microns to 100 microns, such as 0.1 microns to 100 microns.

Partially water permeable - Permeability is the ability of a given material to allow another material to pass through it, which for the present application may be water through the article. The present article comprises the first phase, the water-impermeable engineering polymer, without and with the second phase, the water soluble polymer. If present, the water soluble polymer does not affect the equilibrium transport of water across the material. Transport of water across the material will be from the higher pressure to the lower pressure. For the co-continuous structure, when first exposed to water or after being exposed to water, the higher pressure can be within the structure or the higher pressure can be external to the structure. As such, the interconnecting network can be utilized to deliver water in a controlled fashion to the environment. Alternatively, the interconnected network can be utilized to remove water from the environment and drain to a desired alternate location in a controlled fashion.

The durable partially water permeable article may be made by a process that mixes the first phase, the water-impermeable engineering polymer and a second phase, the second phase comprises at least one component that is a water soluble polymer to form a melt, the melt is then extruded to form a co-continuous structure.

The co-continuous structure may further be machined or altered into a suitable form or structure. Exposure of the co-continuous structure may be done as part of the manufacturing process, or the co-continuous structure may be installed and the natural exposure to water may be utilized to form a durable partially water permeable article.

The co-continuous structure is then exposed to a volume of water to form a durable partially water permeable article. The volume of water may be of sufficient volume to dissolve or erode the second phase, the water soluble polymer, from the co-continuous structure. The volume of water may be of sufficient volume to submerge or immerse the co-continuous structure. The first phase, the durable partially water permeable article is at least partially water permeable, and therefore the second phase, the water soluble polymer may still be present in the durable partially water permeable article.

The durable partially water permeable article may further be machined or altering the article further into desired

### EXAMPLES

### Example 1

15 wt % PEO in PVC/30 phr plasticizer

The following was mixed in a glass vial: Poly(vinyl chloride)—1.46 g Polyethylene oxide—0.25 g Diisononyl Phthalate—0.51 g Methylene Chloride—13.4 g

The mixture was allowed to stand for two days with occasional mixing then dried to constant weight.

### Example 2

10 wt % PEO in PVC/30 phr plasticizer

The following was mixed in a glass vial: Poly(vinyl chloride)—1.66 g Polyethylene oxide—0.18 g Diisononyl Phthalate—0.54 g Methylene Chloride—13.6 g

The mixture was allowed to stand for two days with occasional mixing then dried to constant weight.

### Example 3

5 wt % PEO in PVC/30 phr plasticizer

The following was mixed in a glass vial: Poly(vinyl chloride)—1.84 g Polyethylene oxide—0.09 g Diisononyl Phthalate—0.57 g Methylene Chloride—14.00 g

The mixture was allowed to stand for two days with occasional mixing then dried to constant weight.

### Example 4

PVC/30 phr plasticizer

The following was mixed in a glass vial: Poly(vinyl chloride)—2.03 g Diisononyl Phthalate—0.61 g Methylene Chloride—14.5 g

The mixture was allowed to stand for two days with occasional mixing then dried to constant weight.

### Example 5

5 wt % PEO in PVC Stock—The mixture was used as a stock supply for Examples 6-15.

The following was mixed in a plastic bottle: Poly(vinyl chloride)—14.85 g Polyethylene oxide—0.78 g

### Example 6

5 wt % PEO in PVC/50 phr plasticizer

The following was mixed in a glass vial:

### Example 5—0.97 g Diisononyl Phthalate—0.47 g Methylene Chloride—23.02 g

The mixture was allowed to stand for two days with occasional mixing then dried to constant weight.

### Example 7

5 wt % PEO in PVC/40 phr plasticizer

The following was mixed in a glass vial: Example 5—0.99 g Diisononyl Phthalate—0.39 g Methylene Chloride—26.30 g

The mixture was allowed to stand for two days with occasional mixing then dried to constant weight.

### Example 8

5 wt % PEO in PVC/30 phr plasticizer

The following was mixed in a glass vial: Example 5—1.21 g Diisononyl Phthalate—0.35 g Methylene Chloride—24.88 g

The mixture was allowed to stand for two days with occasional mixing then dried to constant weight.

### Example 9

5 wt % PEO in PVC/20phr plasticizer

The following was mixed in a glass vial: Example 5—1.14 g Diisononyl Phthalate—0.23 g Methylene Chloride—23.68 g

The mixture was allowed to stand for two days with occasional mixing then dried to constant weight.

### Example 10

5 wt % PEO in PVC/10 phr plasticizer

The following was mixed in a glass vial: Example 5—1.31 g Diisononyl Phthalate—0.13 g Methylene Chloride—22.37 g

The mixture was allowed to stand for two days with occasional mixing then dried to constant weight.

### Example 11

5 wt % PEO in PVC/0 phr plasticizer

The following was mixed in a glass vial: Example 5—1.48 g Methylene Chloride—23.23 g

The mixture was allowed to stand for two days with occasional mixing then dried to constant weight.

### Example 12

4 wt % PEO in PVC/20 phr plasticizer

The following was mixed in a glass vial: Example 5—1.46 g Poly(vinyl Chloride)—0.37 g

Diisononyl Phthalate—0.37 g Methylene Chloride—22.72 g

The mixture was allowed to stand for two days with occasional mixing then dried to constant weight.

### Example 13

3 wt % PEO in PVC/20 phr plasticizer

The following was mixed in a glass vial: Example 5—1.35g Poly(vinyl Chloride)—0.93 Diisononyl Phthalate—0.45 g Methylene Chloride—24.49 g

The mixture was allowed to stand for two days with occasional mixing then dried to constant weight.

### Example 14

2 wt % PEO in PVC/20 phr plasticizer

The following was mixed in a glass vial: Example 5—0.81 g Poly(vinyl Chloride)—1.25 g

Diisononyl Phthalate—0.40 g Methylene Chloride—25.31 g

The mixture was allowed to stand for two days with occasional mixing then dried to constant weight.

### Example 15

1 wt % PEO in PVC/20 phr plasticizer

The following was mixed in a glass vial: Example 5—0.74 g Poly(vinyl Chloride)—3.00 g Diisononyl Phthalate—0.74 g Methylene Chloride—23.75 g

The mixture was allowed to stand for two days with occasional mixing then dried to constant weight.

### Example 16

Films by Screw Pressing

Films of polymer blends were prepared by pressing between two steel bolts with the ends polished flat in a steel coupler at 100 to 120 psi pressure and 100 to 110C for 40 min Samples for water immersion testing were removed from the coupler and samples for water diffusion testing were retained in the coupler.

### Example 17

Water Immersion

| | | | | Appearance | |
|---|---|---|---|---|---|
| | wt % | phr | Max | Before | After |
| | PEO in | plasti- | deltaw % | Immer- | Immer- |
| Example | PVC | cizer | in water | sion | sion |
| 1 | 15 | 30 | 133 | translucent | transparent slime |
| (compar- | | | | | |
| ative) | | | | | |
| 2 | 10 | 30 | 94.8 | translucent | opaque/brittle |
| (compar- | | | | | |
| ative) | | | | | |
| 3 | 5 | 30 | 30.9 | translucent | opaque |
| 4 | — | 30 | 7.62 | translucent | opaque |
| (compar- | | | | | |
| ative) | | | | | |
| 6 | 5 | 50 | 29.5 | translucent | opaque |
| 7 | 5 | 40 | 27.3 | translucent | opaque |
| 8 | 5 | 30 | 27.7 | translucent | opaque |
| 9 | 5 | 20 | 33.6 | translucent | opaque |
| 10 | 5 | 10 | 30.2 | translucent | opaque |
| 11 | 5 | — | 20.4 | translucent | opaque |
| 12 | 4 | 20 | 8.67 | translucent | opaque |
| 13 | 3 | 20 | 8.18 | translucent | opaque |
| 14 | 2 | 20 | 5.93 | translucent | opaque |
| 15 | 1 | 20 | 8.57 | translucent | opaque |

Max Delta w % is the maximum measure change in weight of the sample during water immersion, A greater weight change indicates more water in the sample as water on the surface is blotted off with a tissue.

### Example 18

10 psi—100% PVC, 30 phr plasticizer

A film was prepared by screw pressing described in Example 16 using material from Example 4. The film was retained in the coupler and affixed to a water source regulated to 10 psi. After 2 days, the film was still translucent and no water was collected.

### Example 19

10 psi—97% PVC, 3% PEO, 20 phr plasticizer Example 19 uses Example 13 material, A film was prepared by screw pressing described in Example 16 using material from Example 4. The film was retained in the coupler and affixed to a water source regulated to 10 psi. After one day the film had turned opaque and water began to drip from the film surface at 20 mL/h/in².

### Example 20

9.6 wt % PEO in PVC/18 phr plasticizer

The following was mixed in a twin screw extruder at 100C and extruded as thin rods: Poly(Vinyl Chloride)—4.9231 g Poly(Ethylene Oxide)—0.5240 g Diisononyl Phthalate—0.9824 g

### Example 21

5.2 wt % PEO in PVC/20 phr plasticizer

The following was mixed in a twin screw extruder at 100C and extruded as thin rods: Poly(Vinyl Chloride)—5.0423 g Poly(Ethylene Oxide)—0.2783 g Diisononyl Phthalate—1.0641 g

### Example 22

2.9 wt % PEO in PVC/19.4 phr plasticizer

The following was mixed in a twin screw extruder at 100C and extruded as thin rods: Poly(Vinyl Chloride)—5.1560 g Poly(Ethylene Oxide)—0.1563 g Diisononyl Phthalate—1.0299 g

### Example 23

10 wt % PEO in PVC/19.9phr plasticizer/3 phr Filler

The following was mixed in a twin screw extruder at 100C and extruded as thin rods: Poly(Vinyl Chloride)—4.7969 g Poly(Ethylene Oxide)—0.5359 g Diisononyl Phthalate—1.0600 g Calcium Carbonate—0.1619 g

### Example 24

5 wt % PEO in PVC/20.1 phr plasticizer/3.1phr Filler

The following was mixed in a twin screw extruder at 100C and extruded as thin rods: Poly(Vinyl Chloride)—5.1159 g Poly(Ethylene Oxide)—0.2685 g Diisononyl Phthalate—1.0803 g Calcium Carbonate—0.1696 g

### Example 25

2.6 wt % PEO in PVC/19.8 phr plasticizer/3.1 phr Filler

The following was mixed in a twin screw extruder at 100C and extruded as thin rods: Poly(Vinyl Chloride)—5.1831 g Poly(Ethylene Oxide)—0.1397 g

Diisononyl Phthalate—1.0543 g Calcium Carbonate—0.1635 g

### Example 26

0 wt % PEO in PVC/20.5 phr plasticizer/3.1 phr Filler

The following was mixed in a twin screw extruder at 100C and extruded as thin rods: Poly(Vinyl Chloride)—4.6258 g Poly(Ethylene Oxide)—0 g Diisononyl Phthalate—0.9488 g Calcium Carbonate—0.1454 g

### Example 27

5 wt % PEO in PVC/30 phr plasticizer/3.1 phr Filler

The following was mixed in a twin screw extruder at 100C and extruded as thin rods: Poly(Vinyl Chloride)—4.9166 g Poly(Ethylene Oxide)—0.2596 g Diisononyl Phthalate—1.5537 g Calcium Carbonate—0.1610 g

### Example 28

2.3 wt % PEO in PVC/30 phr plasticizer/3.1 phr Filler

The following was mixed in a twin screw extruder at 100C and extruded as thin rods: Poly(Vinyl Chloride)—4.9612 g Poly(Ethylene Oxide)—0.1187 g Diisononyl Phthalate—1.5242 g Calcium Carbonate—0.1577 g

### Example 29

5.1 wt % PEO in PVC/30.2 phr plasticizer/6.2 phr Filler

The following was mixed in a twin screw extruder at 100C and extruded as thin rods: Poly(Vinyl Chloride)—5.0839 g

Poly(Ethylene Oxide)—0.2738 g Diisononyl Phthalate—1.6160 g Calcium Carbonate—0.3314 g

### Example 30

2.6 wt % PEO in PVC/30.1 phr plasticizer/6.0 phr Filler

The following was mixed in a twin screw extruder at 100C and extruded as thin rods: Poly(Vinyl Chloride)—5.1955 g Poly(Ethylene Oxide)—0.1406 g Diisononyl Phthalate—1.6054 g Calcium Carbonate—0.3196 g

### Example 31

5.1 wt % PEO in PVC/10.2 phr plasticizer/3.0 phr Filler

The following was mixed in a twin screw extruder at 100C and extruded as thin rods: Poly(Vinyl Chloride)—5.2325 g Poly(Ethylene Oxide)—0.2794 g Diisononyl Phthalate—0.5605 g Calcium Carbonate—0.1647 g

### Example 32

5.2 wt % PEO in PVC/30.1 phr plasticizer/8.9 phr Filler

The following was mixed in a twin screw extruder at 100C and extruded as thin rods: Poly(Vinyl Chloride)—5.0185 g Poly(Ethylene Oxide)—0.2778 g

Diisononyl Phthalate—1.5933 g Calcium Carbonate—0.4727 g

### Example 33

2.3 wt % PEO in PVC/30.4 phr plasticizer/9.2 phr Filler

The following was mixed in a twin screw extruder at 100C and extruded as thin rods: Poly(Vinyl Chloride)—5.2149 g Poly(Ethylene Oxide)—0.1231 g Diisononyl Phthalate—1.6204 g Calcium Carbonate—0.4902 g

### Example 34

5.1 wt % PEO in PVC/30.0 phr plasticizer/6.3 phr Filler

The following was mixed in a twin screw extruder at 100C and extruded as thin rods: Poly(Vinyl Chloride)—5.1117 g Poly(Ethylene Oxide)—0.2749 g Diisononyl Phthalate—1.6148 g Calcium Carbonate—0.3388 g

### Example 35

Water Immersion

| | wt % | phr | | Max delta | Appearance | |
|---|---|---|---|---|---|---|
| | PEO | plasti- | phr | w % in | Before | After |
| Example | in PVC | cizer | Filler | water | Immersion | Immersion |
| 20 | 9.6 | 18 | — | 7.1 | translucent | opaque/ |
| | | | | | | cracked |
| 21 | 5.2 | 20 | — | 4.3 | translucent | opaque |
| 22 | 2.9 | 19.4 | — | 7.0 | translucent | opaque |
| 23 | 10 | 19.9 | — | 5.3 | translucent | opaque |
| 24 | 5 | 20.1 | — | 3.3 | translucent | opaque |
| 25 | 2.6 | 19.8 | — | 6.8 | translucent | opaque |
| 26 | — | 20.5 | — | 6.2 | opaque | opaque |
| (compar- | | | | | | |
| ative) | | | | | | |
| 27 | 5 | 30.0 | 3.1 | 4.5 | translucent | opaque |
| 28 | 30 | 30.0 | 3.1 | 3.7 | translucent | opaque |
| 29 | 30.2 | 30.2 | 6.2 | 5.3 | translucent | opaque |
| 30 | 30.1 | 30.1 | 6.0 | 7.0 | translucent | opaque |
| 31 | 10.2 | 10.2 | 3.0 | 7.7 | translucent | opaque |
| 32 | 30.1 | 30.1 | 8.9 | 5.4 | translucent | opaque |
| 33 | 30.4 | 30.4 | 9.2 | 7.2 | translucent | opaque |
| 34 | 30.0 | 30.0 | 6.3 | 4.5 | translucent | opaque |

Max Delta w % is the maximum measure change in weight of the sample during water immersion. A greater weight change indicates more water in the sample as water on the surface is blotted off with a tissue. Extruded samples hold their structure better than the solvent processed samples. The water intrusion into the sample can be seen from the translucent to opaque visual change.

The dimensions and values disclosed herein are not to be understood as being strictly limited to the exact numerical values recited. Instead, unless otherwise specified, each such dimension is intended to mean both the recited value and a functionally equivalent range surrounding that value. For example, a weight percentage disclosed as “5 wt %” is intended to mean “about 5 wt %.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An article comprising a co-continuous structure, the co-continuous structure comprising a first phase of a water-impermeable engineering polymer and a second phase comprising at least one water soluble polymer; wherein the water-impermeable engineering polymer is present from 10 wt % to 99.99 wt % by weight of the co-continuous structure.

2. The article of claim 1 wherein the first phase is a water-impermeable engineering polymer is selected from the group comprising polyvinyl chlorine (PVC), acrylonitrile butadiene styrene (ABS) and mixtures thereof.

3. The article of claim 1 wherein the second phase is selected from one or more water soluble polymer selected from the group comprising polyethylene glycol (PEG)/poly ethylene oxide (PEO), polyvinyl alcohol (PVA), and mixtures thereof.

4. The article of claim 1 wherein the water soluble polymer may be present from 0.01 wt % to 90 wt % by weight of the co-continuous structure.

5. The article of claim 1 wherein the co-continuous structure further comprises 1 to 50 phr of an additive.

6. The article of claim 5 wherein the additive comprises calcium carbonate.

7. The article of claim 5 wherein the additive comprises a plasticizer.

8. The article of claim 1 being selected from tube, sheet, container, film, block or a cylinder.

9. A process of making a durable partially water permeable article;
mixing a water-impermeable engineering polymer and at least one water soluble polymer to form a melt;
extruding the melt to form a co-continuous structure; the co-continuous structure comprising an interconnecting matrix of water-impermeable engineering polymer and an interconnecting matrix of at least one water soluble polymer;
exposing the co-continuous structure to a volume of water to form a durable partially water permeable article; and
optionally machining or altering the durable partially water permeable article.

10. (canceled)

11. An article comprising a co-continuous structure, the co-continuous structure comprising a first phase of a water-impermeable engineering polymer and a second phase comprising at least one water soluble polymer; wherein the water-impermeable engineering polymer is present from 50 wt % to 99.99 wt % by weight of the co-continuous structure, further wherein the article comprises interconnecting voids in the first phase having an average diameter of 100 microns or less.

12. The article of claim 11 wherein the water-impermeable engineering polymer is selected from the group comprising polyvinyl chlorine (PVC), acrylonitrile butadiene styrene (ABS) and mixtures thereof.

13. The article of claim 11 wherein the second phase is selected from one or more water soluble polymer selected from the group comprising polyethylene glycol
(PEG)/poly ethylene oxide (PEO), polyvinyl alcohol (PVA), and mixtures thereof.

14. The article of claim 1 wherein the water soluble polymer may be present from 0.01 wt % to 90 wt % by weight of the co-continuous structure.

15. The article of claim 1 wherein the co-continuous structure further comprises 1 to 50 phr of an additive.

16. The article of claim 15 wherein the additive comprises calcium carbonate, a plasticizer and a combination thereof.

17. (canceled)
